(19) United States
(12) Patent Application Publication
(10) Pub. No.: US 2022/0076259 A1
(43) Pub. Date: Mar. 10, 2022

(54) SYSTEM AND METHOD FOR REVERSING BIFURCATED TRANSACTIONS

(71) Applicant: STAC IP, LLC, Wantagh, NY (US)

(72) Inventor: Pino Luongo, Greenwich, CT (US)

(21) Appl. No.: 17/016,120

(22) Filed: Sep. 9, 2020

(51) Int. Cl. G06Q 20/40; G06Q 40/00; G06Q 40/02; G06Q 20/38; G06Q 20/20; G06F 16/23

(52) U.S. Cl. CPC G06Q 20/407; G06Q 40/10; G06F 16/2379; G06Q 20/389; G06Q 20/207; G06Q 40/025

(57) ABSTRACT

A transaction processing system suitable for reversing a merchant transaction, the system comprising a processor, a memory, a first connection over a network for receiving a request to reverse the merchant transaction, and further connections over the network for reversing the merchant transaction; and a transaction reversal module comprising code which, when executed in the processor, configures the processor to provide funds associated with the request to reverse the merchant transaction received over the first connection to a customer, the transaction reversal module including a transaction access module to identify an account where the merchant portion was settled and an account where the tax amount was settled; a settlement determination to determine if the tax portion remains in the second account; an account transfer module operative to settle the merchant portion in favor of a customer account; and a credit ledger module access and update a tax credit ledger.

### FIELD OF INVENTION

The present invention relates to systems in support of commerce, and, more particularly, to a transaction processing system that is suitable for use by merchants, businesses and companies in the restaurant, hospitality, client services, wholesale, and retail industries, to manage tax and fee payments, and refunds relating thereto, in connection with each tendered transaction.

### BACKGROUND OF THE INVENTION

In the retail sector, customers purchase goods and services using cash, credit cards, or debit cards. While some purchases are not subject to taxation, most are. Food and beverage purchases in a restaurant, for example, can be subject to state and local sales taxes.

For each sales transaction that is subject to taxation, a merchant is legally obligated to pay tax at a rate that is set based on the location of the retailer. Thus, in New York City, there may be one rate, whereas in a suburban community outside New York City but still in the state of New York, there may be a different rate, whereas the same sales might not be subject to tax at all in a different state or during a state-sponsored promotional period to encourage shopping.

Merchants are obliged to collect tax from their customers. The collected tax is subject to voluntary reporting, yet the monies collected are co-mingled with other funds collected from operation of the retail enterprise. Meanwhile, the merchant has operating expenses in connection with running the business, such as payroll, inventory, rent, electricity, information services, franchise fees, and so on. It is important for the merchant to maintain accurate accounting records so that the business is not supported by tax revenue that is being held by the merchant until its next tax payment (typically, a monthly or a quarterly payment).

When the sales transaction is made in cash, the merchant receives monies sufficient to cover the sales price and any taxes collected from the customer. When the sales transaction is made by the customer tendering a transaction card (that is, either a debit or credit card), the merchant receives monies in the form of additions to its bank balance in the amount of the sales price and any taxes collected from the customer.

It would be an improvement in the art of such transaction processing to avoid co-mingling for as many sales transactions as possible. It would be a further improvement in the art if the tax revenue collected from a customer were not co-mingled with sales revenue collected by the merchant. Still a further improvement in the art would be a system that transfers to a taxing authority on an automated basis as much of the collected tax as possible substantially when the merchant's bank account is credited with the sales transactions with its customers. For example, such transfer systems and approaches are described in U.S. patent application Ser. No. 15/935,757, filed on Mar. 26, 2018, and U.S. Pat. No. 8,321,281, each of which are herein incorporated by reference as if presented in their respective entireties. However, yet a further improvement in the art would be a system that is configured to permit the refunding of monies paid by a customer using such a bifurcated transaction system. The present invention addresses these and other needs in the art.

### SUMMARY OF INVENTION

In accordance with one aspect of the present invention, a transaction processing system suitable for a merchant in the restaurant, hospitality and retail industry includes a computer having a processor, a memory and a connection to a network, a card reader connected to the computer, and a plurality of modules each comprising code that executes in the processor. Among the plurality of modules, there is a request module which is operative to initiate the transaction reversal process. There is a transaction access module, which is operative to identify the bifurcated portions of a transaction to be reversed. In one or more implementations, there is a settlement module which is operative to cause the merchant to credit the account of a customer for a prior tendered transaction from the identified transaction portions. For instance, the settlement determination module configures a transaction processor to provide funds associated with the request to reverse the merchant transaction received over the first connection to a customer based on the availability of funds in one or more tax settlement accounts.

In accordance with further broad aspects of the invention, a transaction processing system suitable for reversing a merchant transaction is provided. Here, the system can comprise a computer having a processor, a memory, a first connection over a network for receiving a request to reverse the merchant transaction, and further connections over the network for reversing the merchant transaction; and a transaction reversal module comprising code which, when executed in the processor, configures the processor to provide funds associated with the request to reverse the merchant transaction received over the first connection to a customer.

In accordance with further broad aspects of the invention, the transaction reversal module also includes a transaction access module operative to configure the processor to identify a first account where a merchant portion of the prior tendered transaction was settled and a second account where the tax portion was settled and a settlement determination module operative to configure the processor to determine if the tax portion remains in the second account.

In accordance with further broad aspects of the invention, the transaction reversal module includes an account transfer module operative to configure the processor to settle the merchant portion in favor of a customer account from the first account; and settle the tax portion from the second account where the tax portion is accessible from the second account or settle the tax portion in favor of the customer account using an alternative fund source where the tax portion is not accessible from the second account. The transaction reversal module further includes a credit ledger module operative to configure the processor to access a credit ledger of tax portion payments settled to a customer account using the alternative fund source and update the credit ledger when the transaction reversal module credits the customer account from an alternative source. In a further implementation, transaction reversal module sends instructions to a point of sale system to dispense the refund to the customer.

In one or more further implementations, the transaction processor described herein includes a revenue settlement module that is operative to configure one or more processors to settle a revenue portion of one or more approved sales transactions in favor of a first account accessible over the network and belonging to the merchant. The revenue portion excludes the sales tax portion. Meanwhile, the tax settlement module is operative to configure the processor to settle the sales tax associated with the one or more approved sales transactions in favor of a second account accessible over the network, wherein the second account is different than the first account.

In accordance with further broad aspects of the invention, a transaction processing system suitable for processing a merchant transaction comprises a computer having a processor, a memory, a first connection over a network for receiving the merchant transaction, and further connections over the network for settling the merchant transaction, and a separator module comprising code which, when executed in the processor, configures the processor to separate funds associated with the subsequent merchant transaction received over the first connection.

According to more particular aspects of the invention, the separator module can include a revenue settlement module operative to configure the processor to settle a revenue portion of the subsequent merchant transaction in favor of a first account accessible over the network, the first account being associated with the merchant, wherein the revenue portion excludes a tax portion of the subsequent merchant transaction; a tax settlement module operative to configure the processor to access at least the tax payment balance from the tax credit ledger, compare the tax payment balance to the tax portion of the merchant transaction; either settle the tax portion to the primary account where the tax balance is greater than or equal to the tax portion or settle a first portion equal to or less than the tax payment balance of the tax portion of the merchant transaction to the first account where the tax portion is greater than the tax portion and settle a second portion of the tax portion associated with the merchant transaction in favor of a second account accessible over the network, the second account being different than the first account;

In accordance with further broad aspects of the invention, a fee resolution module is provided that is operative to configure the processor to resolve at least one fee associated with operation of the tax settlement module, such that an amount equal to the tax portion is settled in favor of the second account.

According to yet another broad aspect of the invention, a method suitable for reversing a merchant transaction is provided. The method includes using a computer having a processor, a memory, a first connection over a network for receiving a request to reverse the merchant transaction, and further connections over the network for reversing the merchant transaction; and a settlement determination module comprising code which, when executed in the processor, configures the processor to provide funds associated with the request to reverse the merchant transaction received over the first connection to a customer.

In accordance with more particular aspects of the invention, the method includes identifying, using a transaction access module operative to configure the processor, a first account where the merchant portion was settled and a second account where the tax amount was settled; and determining, using a settlement determination module operative to configure the processor, if the tax portion is accessible from the second account. The method further includes settling, using an account transfer module operative to configure the processor, the merchant portion in favor of a customer account; and either settling the tax portion from the second account where the tax portion is accessible from the second account and settling the tax portion in favor of the customer account using an alternative fund source where the tax portion is not accessible from the second account; and accessing, using a credit ledger module operative to configure the processor, a credit ledger recording tax portion payments settled to a customer account using an alternative fund. In a further implementation, the method also includes sending an instruction, using an instruction module operative to configure the processor to format and send an instruction to a point of sale system to dispense the refund amounts.

According to yet another broad aspect of the invention, a method for providing a transaction processing system suitable for processing a merchant transaction, the system including a computer having a processor, a memory, a first connection over a network for receiving the merchant transaction, and further connections over the network for settling the merchant transaction, and a separator module comprising code which, when executed in the processor, configures the processor to separate funds associated with the merchant transaction received over the first connection, is described.

In accordance with more particular aspects of the invention, the method includes settling, by the separator module executing in the processor, a revenue portion of the merchant transaction in favor of a first account accessible over the network, the first account being associated with the merchant, wherein the revenue portion excludes a tax portion of the merchant transaction.

In accordance with more particular aspects of the invention, the method includes accessing at least the tax payment balance from the tax credit ledger, comparing the tax payment balance to the tax portion of the merchant transaction and either settling the tax portion to the primary account where the tax balance is greater than or equal to the tax portion or settling a first portion equal to or less than the tax payment balance of the tax portion of the merchant transaction to the first account where the tax portion is greater than the tax payment balance and settling a second portion of the tax portion associated with the merchant transaction in favor of a second account accessible over the network, the second account being different than the first account.

In one or more further arrangements, the method includes resolving, by the separator module executing in the processor, at least one fee associated with operation of the tax settlement module, such that an amount equal to the tax portion is settled in favor of the second account.

These and further aspects, features and advantages of the present invention will become more apparent from the following detailed description when taken in connection with the accompanying drawings which show, for purposes of illustration only, a preferred embodiment of the present invention.

### BRIEF DESCRIPTION OF THE FIGURES

FIG. 1 illustrates a system arrangement in which a merchant machine connects to a transaction processing module, in accordance with one embodiment of the invention, prior to processing by a transaction card processor;

FIG. 2 depicts a flow diagram illustrating a process by which sales transactions are managed;

FIG. 3 depicts a customer invoice for a sales transaction that has not closed;

FIG. 4 depicts a screen shot of an interface configured to be used in connection with the invention to transfer revenue and tax portions of one or more sales transactions for discrete, non-comingled processing;

FIG. 5 depicts a flow diagram illustrating a tax settlement process in accordance with one or more embodiments of the invention;

FIG. 6 depicts a flow diagram illustrating a process by which fees are assessed during certain sales transactions;

FIG. 7 depicts a flow diagram illustrating a fee settlement process in accordance with one or more embodiments of the invention;

FIG. 8 depicts a flow diagram illustrating a reversal of the settlement process described herein, in accordance with one or more embodiments of the invention;

FIG. 9 depicts a system implementing the reversal of the settlement process described herein, in accordance with one or more embodiments of the invention; and

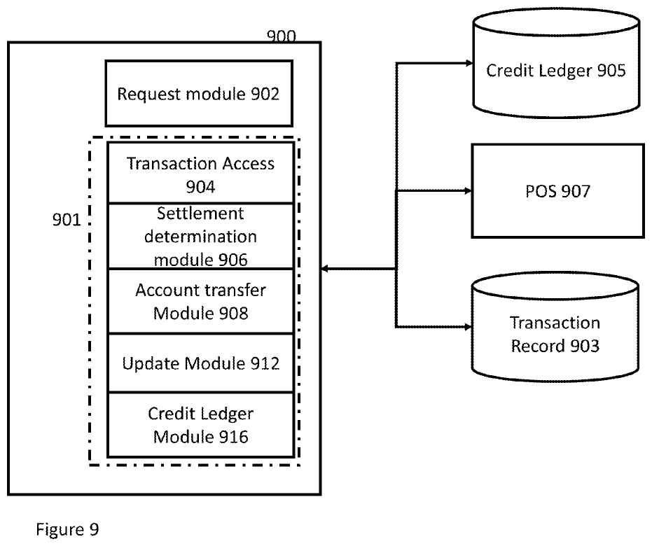

FIG. 10 depicts a flow diagram illustrating crediting a merchant for prior taxes paid in a reversed transaction.

### DETAILED DESCRIPTION OF CERTAIN EMBODIMENTS

By way of overview introduction, the present invention provides improvements in transaction processing by isolating sales revenue from any tax collected by the merchant, such as a merchant in the restaurant, hospitality or retail industry. By isolating the sales tax (or any other applicable tax or taxes) from the revenue portion of a sales transaction, the merchant can manage its business without risk of shortfalls that can result by having the sales tax comingled with sales revenue. This can be a vital improvement for some merchants who are not well schooled in accounting. Equally important, however, is the fact that the isolated tax stream can be provided to a taxing authority on a per-transaction, per-day, per-week, or per-month basis, for example, rather than on a quarterly basis, which is a great advantage to the taxing authority. Furthermore, the isolated tax stream can be protected from or otherwise reimbursed for any fees associated with the transfer of those funds which have been designated for the taxing authority.

There arise circumstances where such bifurcated transactions need to be reversed. For example, when a customer seeks a refund for goods or services purchased, the merchant must provide the customer with the total amount originally paid or tendered. The total amount due to the customer often also includes any sales or other taxes and/or transaction fees that were paid by the customer. Where the merchant bifurcated the transaction but has not yet provided the tax amounts to the taxing authority, the described system is able to account for and transfer the tax portion of the transaction back to the customer. However, there are circumstances where the merchant has already provided the tax portion of the transaction to a taxing authority at the time the refund request is made. In this situation, the merchant will need to account or provide the customer with the tax portion as part of the refund out of the merchant's own account and the system and method disclosed herein are so-configured to do this automatically, under program control and without human user intervention. The foregoing approaches are also directed to ensuring that when the merchant refunds the tax portion from a merchant account, the merchant is able to offset this amount against other tax monies already collected and due to the taxing authority, automatically, under program control, and without human user intervention.

By way for further overview, in one or more circumstances, a merchant has provided the tax portion for a given transaction to the tax authority and does not have a balance in any accessible account. As such, the merchant must use its own funds to credit the customer for the tax portion paid to the taxing authority. In order to account for this circumstance, the transaction processing system described herein is configured to account for the tax amount associated with a particular transaction in a tax credit ledger. Upon processing a new transaction, the payment processor is configured to deduct the balance provided in the tax credit ledger from any tax portion of a new transaction and provide that deducted amount to the sales portion for settlement in the merchant's account, and to do so automatically under control of a processor executing code which so-configures the processor, and to do so without human intervention.

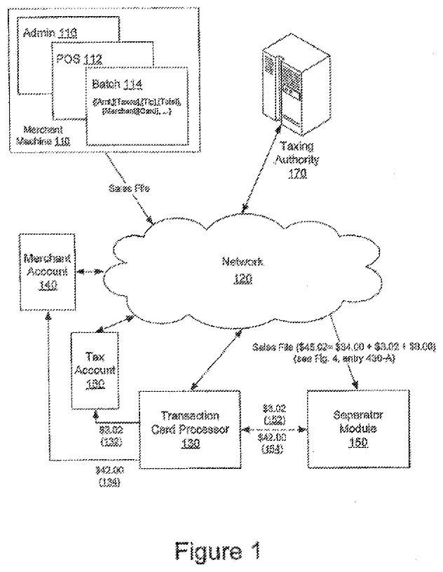

Turning now to FIGS. 1-7, the details of the various systems and implementations of an approach to bifurcating transactions to provide a merchant portion and a tax portion automatically, or otherwise without human intervention, is described. Thereafter, a system and method are provided in connection with implementing refunds to customers in situations in which the merchant transaction has been so-bifurcated.

In FIG. 1, a merchant machine 110 comprises a computer system having network connectivity such as through a wired (e.g., 10/100 Ethernet) or wireless (e.g., IEEE 801.11g) connection to a network 120. The merchant machine includes a processor, memory, and conventional input/output devices such as a touch screen display. Code is loaded or otherwise accessible to the processor and executes to configure the processor as a point of sale device, in the case of POS module 112, or as a transaction processor in the case of Batch module 114, or as an editor in the case of the administrative module 116. Additional modules can be provided, as understood by those of skill in the art, so as to support interactivity with the touch screen or other input/output device, to support communications by and between the modules and over the network 120, to manage data, backups, reporting, and so on.

For instance, the code that comprises the POS module(s) 112 can comprise “Dinerware,” by Dinerware, Seattle, Wash. This software provides a restaurant POS system featuring ticket handling, order routing, menus, business policies, labor management functionality, and so on. Other POS software can be used in the merchant machine 110 with equal advantage, including, by way of example and not limitation, “PointOS Professional” by PointOS, “Halo” by Vivonet, and “Cash Register Express” by PC America. As another example, the code that comprises the transaction module(s) 114 can comprise “Slipstream” by Midnite Express, Inc. of Myrtle Beach, S.C. The “Slipstream” software provides transaction processing system suitable for multiple credit card, gift, and loyalty card usage, including, in relevant part, batch processing of sales transactions to third-party transaction card processing facilities. The administrative module(s) 116 can comprise code that is a part of the POS or batch software, and generally designates functionality that can support configuration of the interface including the buttons and their labels, password management, licensing, setting of tax rates, pre-set gratuity levels, gift certificate processing, and other settings that the merchant might configure and save in a profile associated with a particular establishment or a chain of retail establishments.

Conventionally, the merchant machine 110 communicates over the network 120 to a transaction card processor 130 which receives a sales file output by the merchant machine and processes one or more sales transactions in the sales file so as to credit a merchant account 140 (which includes the data 430 in several rows of the interface 400). There are many transaction card processors 130 around the U.S.A. and all over the world that receive such files and perform merchant services such as processing third-party transactions and attending to interchange fees and other service charges, chargebacks and reversals, if any. For instance, First Data Merchant Data Services Corporation (“First Data”), 5th 3rd, Heartland, American Express CAPN, etc. The merchant account can be an account at any traditional or online banking institution. The merchant account 140 is characterized by having a routing number and an account number. Together, these numbers enable funds to be directed from the transaction card processor 130 to a particular account associated with the merchant.

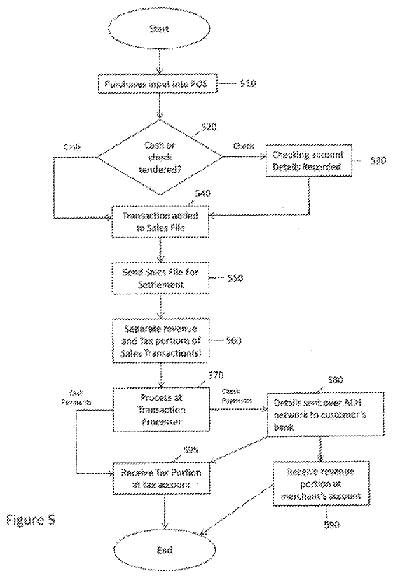

It should be noted that while the embodiment described herein relates to merchant transactions conducted using a credit card or debit card, as is discussed in detail below in relation to FIG. 5, in instances in which a customer prefers to pay using cash or check the invention can similarly be performed using a suitably configured transaction processor in accordance with one or more embodiments of the invention that can process cash/check payments.

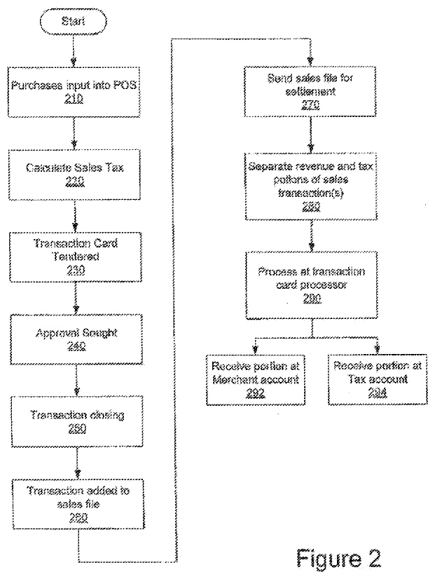

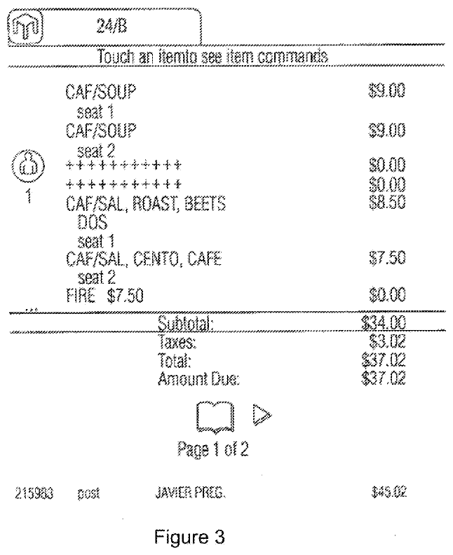

Turning briefly to FIG. 2, a first portion of a process flow 200 (steps 210 through step 270) illustrates a conventional sales transaction by a customer with a merchant using a credit card or signature-based debit card. A customer makes purchases at a merchant in a conventional manner. The purchase can be for goods or services. For instance, the purchase can be food (soup, appetizer, drink) from a restaurant. The customer's choices are input into a POS system at step 210. In FIG. 3, the POS system comprises the aforementioned Dinerware software that is executing for the benefit of the restaurant, such as in a machine located at the site of the restaurant. The purchases subtotal to $34.00. At step 220, tax is calculated such as by operation of a check presentation module comprising code executing in the machine that implements the POS in relation to the price of a product sold to the customer for the particular location of the retailer and/or the customer. The taxes are calculated (e.g., $3.02), and the calculated amount is added to the subtotal to yield a total amount due ($37.02 in the illustrated example).

If the customer tenders cash, the process continues as described below in connection with FIG. 5. However, when the customer wishes to pay using a transaction card, or several transaction cards as when the cost is split among several people, the transaction card is tendered as shown at step 230 by causing the card to be swiped or otherwise read (e.g., using a near-field RFID technology) or provided to the POS via an input device. More generally, a card reader is connected to the computer providing the POS functionality and the card reader transfers transaction card data from a credit card of a customer to a memory of the computer.

As indicated at step 240, approval of the tendered card is sought such as by communicating over the network 120 to a transaction card processor 130 associated with the particular card that was tendered (e.g., Visa, MasterCard, American Express, etc.). In a conventional manner, the card processor returns a code if the amount sought for approval is within the credit limit of the credit card, or within the parameters permitted for a debit card, if that was the card that was tendered. In the case of restaurants, the approval may be for an amount that exceeds the purchase amount ($37.02) to ensure that a gratuity (e.g., a 15%-20% overage) can be approved in case the customer adds a gratuity to the purchase amount as is customary for customers of some merchants. An approval module comprising code executing in the machine that implements the POS manages the actions necessary to communicate an amount to the transaction processor for approval against the transaction card data that has been read into the memory of the POS machine and to receive an acknowledgement of the approval. This amount, namely, at least the price of the product and the applicable tax or taxes (e.g., local, state, federal, etc.), defines an approved sale transaction. For online purchases, this can also include any associated shipping and/or handling costs. The acknowledgements can be stored locally at the merchant site or remotely, along with the sales transaction details with that customer. Among other data concerning the transaction that can be stored are the following (all of which can be part of a sales file later communicated to the transaction processor 130 for settlement):

[Date]
[Time]
[Check]
[User]
[Card]
[Card #]
[Approval]
[Amt.]
[Tax]
[Tip]
[Total]
[Tip %]
[Merchant]
[Other]

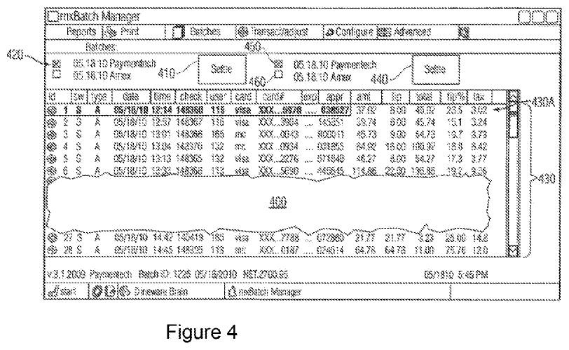

If the approval is obtained, then the process flow continues so as to close the transaction, as indicated at step 250. If approval is denied, the customer may be requested to provide alternate payment information, which can be received by the POS. Upon confirmation of the approval, a transaction closing module comprising code executing in the machine that implements the POS operates to fix the total amount of the purchase, any tax, and any gratuities or costs that are being charged to the customer. The transaction closing module can close the sales transaction in an amount up to the approval defined in the approved sale transaction. That total amount, and some or all of the values of the variables listed above, are included in a row of a table or in a record or other data object that is included in a sales file that is communicated over the network 120 to a transaction card processor, typically at the request of the merchant, as indicated at step 270. The sales file is sent out, for example, by interacting with a settlement control 410 that is provided within the interface (see FIG. 4), or by any other appropriate form of electronic communication.

In accordance with various embodiments of the invention, the term “settlement” can be used to generally refer to the process in which a transaction is accepted for financial settlement between an issuing bank and a merchant's acquiring bank. The settlement process is a complex accounting process that ensures that interchange rates are applied, all participants in the transaction process have their fees applied and are paid, and the correct banking transfers are initiated to move funds from the issuing bank to all the relevant participants in the transaction.

The settlement control is selectable by a user of the transaction processing system (e.g., the POS) to trigger a revenue settlement module, a tax settlement module, or both, to cause a transmission over the network to settle the one or more approved sale transactions. The merchant selects a payment processor, such as one associated with the Visa and Mastercard tenders, for example, by interacting with a check box 420 and can, in a batch mode, send all transactions of that tender type at once, simultaneously (e.g., all of the illustrated transactions in a batch manager window 400). The sales transaction of FIG. 3 is shown in the first row, row 430-A, of FIG. 4. As will be understood from the description that follows, either or both a revenue portion of the sales transaction and applicable sales tax can be sent out by the code of the settlement module, simultaneously, in a batch.

Referring now to FIGS. 1, 2 and 4, in accordance with a salient aspect of the invention, the sales file is processed by a separator module 150 which comprises code executing in a processor of a machine and operative to separate sales tax from a revenue portion of the sales transactions. It should be understood that the separator module can be executed on the machine that implements the POS, or can execute on a different machine accessible to the POS over the network 120. For instance, the functionality of the separator module can be a hosted solution that merchants can subscribe to in order to facilitate transaction card processing in a manner that eliminates co-mingling of sales or other applicable tax with operating revenue. The machine providing the hosted solution can be a machine of the transaction processor or of a third party. It should be noted that in instances where the separator module is part of a hosted solution, the POS can provide the separator module with the single data file over the network 120 for settling. In instances where the separator module is integrated with the POS, the separator module can process the sales file as described below, and then provide two data sets over the network 120 to the transaction processor 130 for settlement. In any implementation, the merchant transaction to be settled can transmit one or more account numbers and routing numbers to be used in the settlement of funds, or the recipient of the sales file can maintain (e.g., in an encrypted and /or otherwise secure manner) such information that can be retrieved from a data store and accessed using information in the sales file (e.g., the merchant identifier). The data store can be at the transaction processor or at the merchant, such as in the POS system, for example.

The code of the separator module 150 comprises a revenue settlement module that is operative to configure the processor of the machine on which it executes to settle a revenue portion of the approved sales transactions included in the sales file. The settlement is in favor of a first account that is accessible over the network, such as the merchant account 140 which belongs to the merchant. The revenue portion of the sales transaction excludes the sales tax, but can include any gratuity or tip, if applicable. (The purchase revenue and any gratuities are managed by conventional POS software, so that the merchant can divide tips among waiters and other staff according to their respective customers served, and/or in accordance with other business rules.) The code of the separator module 150 also comprises a tax settlement module that is operative to configure the processor of the machine on which it executes to settle any sales tax associated with the approved sales transactions in the sales file. The settlement in this regard is in favor of a second account accessible over the network, preferably one that is different than the first account. In one implementation, the settlement to the second account can be to an account of a taxing authority 170, such as tax account 160. In one or more alternative implementations, the second account is an account controlled by the merchant and accessible by the POS system that is configured to receive the tax portion of the funds prior to a batch settlement of the tax portion of bifurcated transactions to a tax account of a taxing authority.

Optionally, when the separator module executes within the machine that implements the POS, the settlement control 410 can be configured to trigger a transfer to the transaction processor 130 just the revenue portion of the sales transaction(s), while a second control 440 can be provided and configured to trigger a transfer to the transaction processor 130 just the sales tax portion of the sales transaction(s). Each control can be for tenders of one type or another, such as Mastercard and Visa on the one hand by selecting check box 450 (as shown) or American Express by selecting check box 460.

At step 280, the separator module executes to provide to the transaction processor 130 two data sets, one designated to each of the first and second accounts. For instance, the separator module can include a routing number and an account number associated with each of the first and second accounts to the transaction processor 130. The transaction processor is thereby enabled to settle the transactions in the separated sales files to distinct accounts free of any co-mingling of sales tax with sales revenue.

The revenue settlement module and the tax settlement module each are preferably in communication with a database so that the transmission to the transaction processor 130 can forward data useful in settling the sales transactions. In one implementation, the communication to a database comprises the communication of the sales file message from the machine 110 of the merchant to the separator module 150. The sales file or database can provide an identifier of the first account; an identifier of the merchant that caused the transmission; an amount of the revenue portion of the one or more approved sales transactions; an amount of the sales tax associated with the one or more approved sales transactions; a date for each respective one of the one or more approved sales transactions; a time for each respective one of the one or more approved sales transactions; or a selection of these data.

At step 290, the third-party transaction processor receives from the separator module 150 at least two data sets, one concerning a revenue portion of one or more sales transactions and a sales tax portion of the same group of sales transactions. Referring again to the example in FIG. 3, if the communication from the separator module 150 is of one sales transaction rather than a batch of transactions, then the POS provides a sales file to the separator module and the separator module operates to output a divided or otherwise identified version of the sales file with portions suitable for settling both the sales revenue portion (arrow 152) and the sales tax portion (arrow 154). For instance, instead of settling the amount in the “Total” field as received from the POS, the fields can be remapped so that the Total, which is used by the transaction processor 130 has, in the case of the revenue portion, the sum of the Amt and Tip columns (and thus excludes the Tax column), and, in the case of the sales tax portion, the Tax column. In another implementation, the fields are unaltered, but the pertinent fields are identified to the transaction processor for settlement (that is, there is no re-mapping of the columnar data). In still another implementation, the Tax column data is omitted to cause a recalculation of the Total for use in settling the revenue portion of the sales transaction(s), and the Amt and Tip column data are omitted to cause a recalculation of the Total for use in settling the sales tax portion of the sales transaction(s).

Regardless of the approach taken, the transaction processor settles the sales transaction(s) so that the merchant account can receive at step 292 the revenue portion (arrow 134) and so that the second account 160 (e.g., tax account) can receive the sales tax component (arrow 132) of the sales transaction(s) at step 294. As such, the revenue settlement module and the tax settlement module can be understood as being configured, in accordance with the invention, to settle the revenue portion of the one or more approved sales transactions and the sales tax associated with the one or more approved sales transactions free of any comingling of those respective portions of the amount tendered by a customer in each closed sales transaction.

As mentioned above, in instances in which a customer prefers to pay using cash or check the invention can likewise be performed to prevent comingling of those respective portions of the amount tendered by a customer in each closed sales transaction (namely, the revenue portion and the tax portion), by employing a transaction processor configured by code executing therein to handle cash/check payments in a manner similar to the process described in relation to FIG. 2. For example, turning now to FIG. 5, at step 510, details of a purchase are input to a POS in a conventional manner. As described in step 220 of FIG. 2, the tax is calculated such as by operation of a check presentation module comprising code executing in the machine that implements the POS based on the price of a product sold to the customer for the particular location of the retailer and/or the customer.

At step 520, when the customer tenders cash or a check, the merchant may still desire to keep revenue and taxes from comingling. If a check is tendered (e.g., a personal check drawing on a personal checking account, a cashier's check, etc.), the checking account details (a routing number and an account number associated with the customer's form of payment) and the amount tendered are recorded at step 530. In a variation of the foregoing, the purchase can be by credit card, debit card, or other electronic payment (e.g., a NFC-enabled device payment) in the manner discussed above in connection with FIG. 2 using the modules discussed in connection with that Figure, while any further processing in view of the payment being by cash or check continuing as described here in connection with FIG. 5.

Recording can be accomplished by using an image capture device, such as a scanner or camera, or by entering the check details manually into the POS. At step, 540, the account details, as well as the purchase information, are added to the sales file. If cash (dollar bills and/or coins) is tendered, the purchase information and the amount tendered are similarly added to the sales file at step 540.

Continuing at step 550, the sales file is communicated over the network 120 to a transaction processor, typically at the request of the merchant. It should be noted that, depending on the system employed by the POS and the transaction processor handling the payment processing, a merchant may be required to generate separate files for cash transactions and checking transactions, and process each payment type separately if necessary. At step 560, the separator module executes to provide to the transaction processor two data sets generated from a single sales file, one designated to each of a first (merchant) account and a second (tax) account. The first data set can contain an amount to be transferred to the merchant account, and the second data set can contain an amount to be transferred to the account of the taxing authority. For instance, the separator module can provide a routing number and an account number associated with each of the first and second accounts to the transaction processor. The transaction processor is thereby enabled at step 570 to settle the transactions in the separated revenue and tax files to distinct accounts free of any co-mingling of sales tax with sales revenue.

It should be noted that for cash payments, because the merchant already has “cash-in-hand,” once the cash sales file is separated into two data sets by the separator module, only the tax portion need be transferred from an account of the merchant (or a third party, such as a parent company) to an account of the taxing authority. Alternatively, however, the second data set representing the revenue portion can be configured by the separator module to specify zero (additional) dollars to be conveyed.

For check payments, at step 580 the transaction processor can send each of the data sets received from the separator module via a dedicated check processing network, such as the Federal Reserve's Automated Clearinghouse (ACH) network to the customer's bank for further processing. Upon receiving one or both data sets, as described above, the customer's bank will allocate funds from the customer's checking account and transfer those funds to each of the first (merchant) account (step 590) and a second (tax) account (step 595), in accordance with the content of the respective data sets. On the other hand, for a cash payment transaction, only the tax portion from any cash payment processed by the transaction processor is received at the account of the taxing authority.

As a consequence, employing the herein described transaction processing system for either credit/debit card-based purchases or cash/check based purchases, the second account has access to monies associated with a tax portion of the sales transactions at a merchant location substantially contemporaneously with the merchant having access to the monies. When the second account is one belonging to a taxing authority, the taxing authority obtains access to tax revenue on a daily, weekly, bi-weekly, or monthly basis rather than a quarterly basis. Likewise, when the second account is controlled by the merchant, but contains monies due to the taxing authority, the second account can be configured to automatically provide the taxing authority with the monies of the second account on a daily, weekly, bi-weekly, or monthly basis. The merchant, meanwhile can be accorded read access to the second account, or another account that is linked to payments made through the second account, so as to monitor the amount of payments made, say, in a given calendar quarter, and so on.

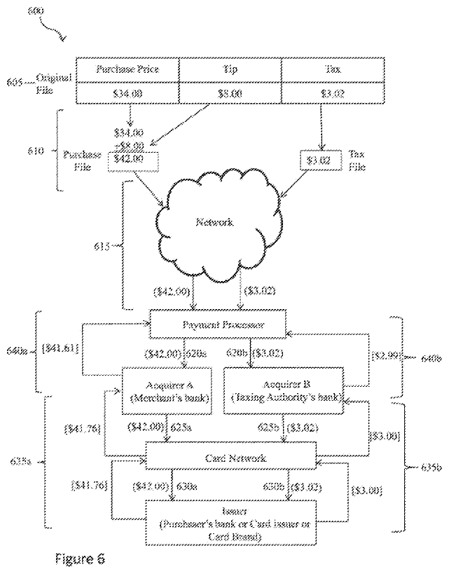

As discussed above, in conjunction with merchant services, an electronic payment processor such as transaction card processor 130 can process third-party transactions and attend to interchange fees and other service charges, chargebacks and reversals, if any. Such fees are often requested by the merchant's bank, the purchaser's (customer's) bank/card issuer, the credit card company/network, etc., and are typically assessed to the sales transaction as the funds are being transferred from the purchaser's account to any account that is to be funded. By way of example, flow process 600 of FIG. 6 shows one way in which the sales transaction settlement process of FIGS. 1-4 can be affected by the assessment of fees by various parties in the settlement process. At step 605, the transaction details of the example sales transaction of FIG. 3 are stored in the original sales file (as indicated on row 430A of FIG. 4). As discussed above (FIG. 2, step 280), at step 610 the separator module 150 can process the sales file so that the revenue portion—the purchase price and tip totaling $42.00—can be separated into a purchase file, and the tax portion—totaling $3.02—can be separated into a tax file. At step 615 the two files can be sent over network 120 to a payment processor such as transaction card processor 130 for further processing. As discussed in further detail below in relation to method 600 of FIG. 6, it should be understood that in alternative embodiments, such as in the hosted solution discussed above, a single data file including the revenue portion and tax portion can be sent by the merchant over network 120 or otherwise provided to the transaction processor having a separator module, at which time the revenue portion and tax portion can be separated and processed separately.

At steps 620a and 620b, the payment processor distributes the purchase file and the tax file to Acquirer A (the merchant's bank) and Acquirer B (the Taxing Authority's bank) respectively. It will be appreciated that Acquirer A and Acquirer B can actually be the same bank with two separate accounts, one for the merchant and one for the Taxing Authority. An acquirer is typically a bank or other financial institution that hosts an account to which funds are ultimately destined to be deposited at the end of an electronic sales transaction. The payment processor therefore provides each Acquirer with the amount to be requested from the issuer of the purchaser's bank/credit card by the Acquirer—indicated in FIG. 6 in parenthesis as ($42.00) and ($3.02), respectively. At steps 625a and 625b, Acquirer A and Acquirer B each send their respective requests to a card network, and the requests of ($42.00) and ($3.02) are then submitted to the Issuer at steps 630a and 630b. The card network acts as an intermediary between the

Acquirer and the Issuer to authorize and settle credit card transactions, and can provide payment instructions as required.

Apart from the original transaction having been separated by the separator module into two files identifying distinct accounts and optionally distinct banks, the processing of the transaction can proceed in a conventional manner. It should be noted that while in the example embodiment described herein approval is sought for the total sales transaction amount prior to any bifurcation by the separator module (see FIG. 2, step 240), in other embodiments, approval can be sought for each of the tax portion and the revenue portion after bifurcation by the separator module. This is appropriate, for example, in instances where a customer chooses to make a payment using a PIN-based debit card or debit-linked NFC-enabled device (requiring a customer to enter a personal identification number at the POS), wherein a single communication is used for both authorization and settlement, rather than as separate processes.

The Issuer typically charges the merchant an interchange fee for each amount requested. An interchange fee is a fee paid by a merchant to a credit card issuer and a card network in exchange for accepting and handling credit card payments, and can be charged as a flat fee and/or a percentage of the requested amount. Interchange fees are commonly collected by the issuer and shared with the card network. In the example of FIG. 6, at step 635a, Issuer charges Acquirer A an interchange fee of 24¢ and sends the revised amount—indicated in square brackets as [$41.76]—via the card network to Acquirer A for settlement. Similarly, at step 635b, Issuer charges Acquirer B an interchange fee of 2¢ and sends the revised amount—indicated in square brackets as [$3.00]—via the card network to Acquirer B for settlement.

Once an acquirer receives a revised amount from an issuer, the acquirer then typically charges the merchant a discount fee. A discount fee is a processing fee paid by the merchant to the acquirer to reimburse the acquirer for the cost of processing the credit card payment. In the example of FIG. 6, at step 640a, Acquirer A charges the merchant a discount fee of 15¢, settles the payment with the merchant's account, and reports the revised amount—now [$41.61]—to the payment processor. Similarly, at step 640b, Acquirer B charges the merchant a discount fee of 1¢, settles the payment with the Taxing Authority's account, and reports the revised amount—now [$2.99]—to the payment processor. The payment processor thereafter can provide periodic statements (e.g., monthly, quarterly, etc.) to both the merchant and the Taxing Authority's bank, reflecting the transactions handled during a respective period.

In this example, the communications to and from the payment processor, the card network, the issuer, and any further intermediaries include information that traces the transaction back to the purchase file and the tax file, respectively, or comprise modifications to the purchase and tax files to track the status of the communications. Of course, this example does not include fees charged to the merchant by the payment processor for processing the sales transactions, any third-party fraud monitoring services, etc., which would also typically be subtracted from the funds issued by the issuer. It should be noted that even in other payment processing network configurations, such as if only one acquirer (for example, Acquirer A) was used initially to request the total amount ($45.02) of the funds from the issuer and then the tax portion was separated subsequently, there would still typically be fees associated with the transfer of those funds from Acquirer A to Acquirer B which could result in less than the total tax portion being deposited in the Taxing Authority's account.

Therefore, in accordance with further embodiments of the invention, separator module 150 can further include a fee settlement module (not shown), which comprises code that executes in a processor in order to provide the full amount of the tax portion of a sales transaction from the tax file at step 610 to the tax account 160. The fee settlement module operates to configure the processor of the machine on which it executes to settle any fees associated with the tax portion in favor of the revenue portion of the sales transaction.

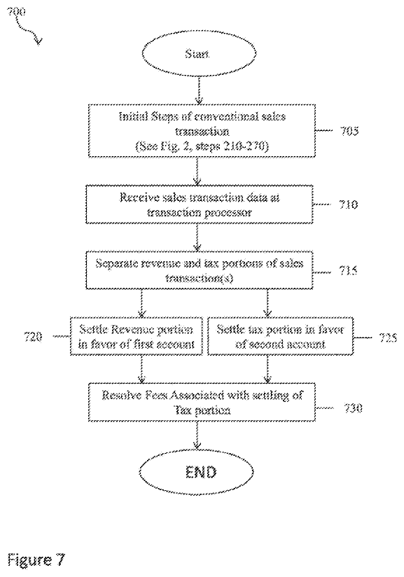

Turning now to process flow 700 of FIG. 7, in accordance with embodiments of the invention, in step 705 a sales transaction can be conducted between a customer and a merchant using, for example, a credit card, as described above in detail regarding the first portion of process flow 200 (FIG. 2, step 210 through step 270). Alternatively, any other conventional electronic payment method can be employed, such as by using an NFC-enabled device, an online payment account, etc. As generally described above in relation to FIG. 1, at step 710 the merchant machine 110 communicates over the network 120 to a transaction processor which receives one or more sales file outputs by the merchant machine and processes one or more sales transactions in each sales file so as to credit merchant account 140 and tax account 160. In accordance with embodiments of the invention, depending on the configuration of the system and merchant/transaction processor network, sales transaction data can be received at the transaction processor for processing either as a single data file including both the revenue portion and the tax portion which is to be separated by the transaction processor as indicated in step 715, or can comprise two data files, each having already been separated into the appropriate amounts for the revenue and tax accounts by code executing in a merchant machine, such as the merchant POS, prior to receipt by the transaction processor.

At step 720, the revenue settlement module utilizes code executing in the processor of the machine on which it executes to settle the revenue portion in favor of merchant account 140. As discussed above, there are likely to be an assortment of fees associated with the revenue settlement, including interchange fees, discount fees, fraud-monitoring fees, etc. However, as these fees are drawn from the revenue that flows from the customer to the merchant by the various entities requesting the fees, and as the merchant is responsible for the payment of these fees, no further action is required by the separator module in settling the revenue portion.

At step 725, the tax settlement module utilizes code executing in the processor of the machine on which it executes to settle the revenue portion in favor of the tax account. However, unlike with the revenue portion, the merchant is responsible for paying the full amount of the tax portion that has been tendered by the purchaser (customer) during the sales transaction, and, in accordance with a salient part of this aspect of the invention, further code executes to ensure that the full amount is deposited in tax account 160. In particular, as indicated at step 730, the fee settlement module comprises code that configures the processor of the machine on which it executes to settle any fees associated with the tax portion so that an amount equivalent to the full tax portion paid by the purchaser is provided to tax account 160 notwithstanding any fees paid in connection with the processing of the card transaction. The fee settlement module can execute to provide such funds in a number of ways, a few of which are described below.

In accordance with embodiments of the invention, the fee settlement module can be configured to monitor the tax portion for any fees deducted during the settlement of the tax portion in favor of the tax account (during operation of the tax settlement module). Monitoring can be accomplished by tracking the stated amount of the tax portion as it is transferred from the Issuer to tax account 160, for example, by review the processes performed by the tax settlement module. Alternatively or additionally, fee settlement module can monitor tax account 160 directly and compare the amount posted to tax account 160 with the original tax portion and flag any discrepancies such as by storing in a memory the amount of the discrepancy and the tax account involved.

If the fee settlement module determines that a fee or fees have been deducted from the tax portion at any point during the tax settlement process (during operation of the tax settlement module), the fee settlement module can appropriate funds equivalent to the fee or fees from an alternative source to augment the tax account. The alternative source can be the revenue portion, in which case funds equivalent to a fee total can be diverted to tax account 160 rather than to merchant account 140. The alternative source can be merchant account 160, in which case funds equivalent to a fee total can be transferred from merchant account 140 to tax account 160 to compensate for the fees deducted. Finally, the alternative source can be a pre-determined third account that is designated to reimburse tax account 160 for any fees deducted from the fee portion. This can be an alternate account under the control of the merchant or may be that of a third-party, such as, for example, a third party payment processor that can bill the merchant later for any fees paid on the merchant's behalf to tax account 160. In any of these scenarios, the discrepancy that has been flagged can be matched to a user-configurable setting of the particular alternative source from which to satisfy the discrepancy, and the fee resolution module can initiate a transfer (or instruct a transfer) from that source in favor of the tax account.

In accordance with further embodiments of the invention, the fee settlement module can comprise additional code that configures the module to preemptively assess whether any fees are to be deducted from the tax portion by determining a fee resolution estimate. If the fee settlement module is so configured to define a fee amount that is to be deducted from the tax portion during the tax settlement of a given purchase transaction, then the fee settlement module subtracts the defined fee amount from the revenue portion to be requested from the Issuer and adds the defined fee amount to the tax portion. In this case, the tax portion will be processed through the network with sufficient additional funds to offset any fees to be deducted.

In the example of FIG. 6, the fees owing on processing the tax portion of the purchase transaction amounted to $0.03, and so the data files can be separated into $41.97 and $3.05 (instead of ($42.00 and $3.02 respectively) in order to better ensure that the final amount deposited to Acquirer B's account is the full tax amount of $3.02. However, the code executing in the fee resolution module can be further configured to account for the increase in the tax portion incurring further processing fees, such as in the case in which the tax portion is sizeable, and cause an incremental amount to be transferred beyond the fees due for the true tax portion to account for the incremental fees due to funding the tax portion to net the Acquirer B account at the full tax portion amount (e.g., to ensure $3.02 is funded). Additional processing fees in such an instance can be incurred based on a number of factors, such as the type of credit card tendered, the type of bank account(s) involved in the transaction, which financial institution is being used, the amount tendered, etc. Typically, each credit card company will set a scale or formula by which processing fees are to be assessed. Likewise for bank accounts, a “small-business” account may have one scale or formula associated with processing fees, whereas a “premium” account may have a different scale or formula associated with processing fees for the same transaction. Finally, different banking institutions may offer different processing fee scales or formulas, for example, as a way of attracting business. Processing fees may be a set amount, proportional, incremental (linear), exponential, and/or may be based on set ranges, tiers, thresholds, or any combination thereof.

The fee resolution module can therefore be further configured to account for the increase in the tax portion incurring further processing fees, by assessing the relevant processing fee structures associated with the transaction, determining whether processing the tax portion will cause such additional processing fees to be incurred and, if so, calculating the expected additional amount and resolving the additional processing fees by one of the methods described herein of fee resolution.

For example, two new cars may be sold for the same price ($27,000.00) by one merchant car dealer to two customers, Purchaser A and Purchaser B. If the sales tax on a new car sold by a merchant car dealer is 4%, the taxes assessed for each transaction will be $1,080.00. Purchaser A may tender a credit card for which additional processing fees are assessed on a $1.00-per-$100.00 formula for any tax portion above $100.00, with a cap at $15.00 in additional processing fees. The additional processing fees in this instance would be $9.00, to compensate for the $980.00 above the initial $100.00. Purchaser B, however, may tender a credit card for which additional processing fees are assessed based on a tiered scale, with the first $1000.00 assessed a flat rate of $10.00 in fees, and each additional dollar assessed a 5¢ charge, for a total of $14.00 in processing fees. Therefore, the fee resolution module can comprise additional code that configures the module to assess the relevant processing fee structures for each credit card tendered, determine whether processing the tax portion will cause such additional processing fees to be incurred and, if so, calculate the expected additional fees and resolving the additional processing fees by one of the methods described herein of fee resolution.

In the example above, for each transaction, upon detecting that additional processing fees will be incurred based on the credit card tendered, the fee resolution module is configured to calculate the expected fees and resolve the transactions accordingly. For the fees associated with Purchaser A's credit card, the additional processing fees are offset by separating the data files into $26,991.00 and $1009.00 (instead of ($27,000.00 and $1,000.00 respectively), in order to better ensure that the final amount deposited to the Taxing Authority's account is the full tax amount of $1,000.00 after the $9.00 processing fee is incurred. Likewise, the fee resolution module will resolve the transaction associated with Purchaser B's credit card by separating the data files into $26,986.00 and $1014.00 (instead of ($27,000.00 and $1,000.00 respectively) in order to better ensure that the final amount deposited to the Taxing Authority's account is the full tax amount of $1,000.00 after the $14.00 processing fee is incurred.

The incremental fees may result in a saving of fees in the revenue account depending on the applicable fee schedule and the reduction in the amount in the revenue account. The final amount deposited in tax account 160, after operation of the fee settlement module, is equivalent to the amount paid by the customer in tax. This process is particularly convenient in embodiments in which the transaction processor receives a single data file and the separator module then separates the total amount into the revenue portion and the tax portion, because the defined fees and any incremental fees can likewise be separated and included with the tax portion prior to processing as part of a since separating procedure, and this can all be performed by the transaction processor without human intervention.

In accordance with yet further embodiments of the invention, the fee settlement module can be configured to isolate the tax portion from being subject to a disbursement of fees. This can be accomplished, for instance, by the fee settlement module designating the tax portion as a file from which no fees are to be taken. As requests or attempts are made to deduct fees from the tax portion, the fee settlement module can notify a requester of the fee or fees to draw the fee-equivalent funds from one of the alternative sources described above, or to automatically provide the requester with the fee-equivalent funds from the alternative source. Such collaboration can be prearranged between the merchant, transaction processor (if different than the merchant), the acquirer(s), the issuer, etc., so as to remove any encumbrances from impeding the process of successfully isolating the tax portion for settlement with tax account 160.

It should be noted that with any of the above described fee reimbursement processes, fees can be reimbursed on a per-fee basis as fees are deducted, or simultaneously in a batch, for example, once all fees have been deducted. Additionally, a batch of fees can be reimbursed for a single sales transaction or a batch of sales transactions, and fee reimbursement batches can be processed immediately or a later predetermined time, such as one per day, once per week, etc. Finally, it should be clear to those of ordinary skill in the art that the above described fee reimbursement processes can be employed to settle fees associated with the merchant's account in favor of alternative sources as well, for example, when the merchant's fees are paid by a parent company or franchisor.

In accordance with further embodiments of the invention, while tax and fee settlements can be enabled on a per-transaction basis or per-batch basis, transaction reports reflecting the myriad transactions handled by the transaction processing system can be generated periodically (e.g., daily, monthly, quarterly, etc.) For example, a merchant employing a software program as described above with regard to POS module(s) 112, can generate a transaction report reflecting all the merchant's transactions handled by the transaction processing system during a particular period, including all tax and fee related details.

Furthermore, in order to verify that the transaction processing system is properly processing the merchant transactions, the transaction processing system can further include a statement reconciliation module. The statement reconciliation module can be configured to receive two or more of the following: (a) merchant transaction reports, (b) merchant bank account statements, (c) payment processor reports, and/or (d) Taxing Authority (ACH) bank account statements (or, at minimum, the relevant information reflecting transactions with a particular merchant as provided by the Taxing Authority). The statement reconciliation module can compare the different data sets from the various statements/reports received, and flag any discrepancies. The statement reconciliation module can be further configured to reconcile any discrepancies between the data sets, and report the results to the merchant, payment processor, and/or the Taxing Authority. In doing so, merchants will be assured that they have delivered the correct tax revenue to the Taxing Authority, the payment processor will be assured that all fees have been paid, and the Taxing Authority will be assured that it has received the appropriate tax revenue from the merchant.

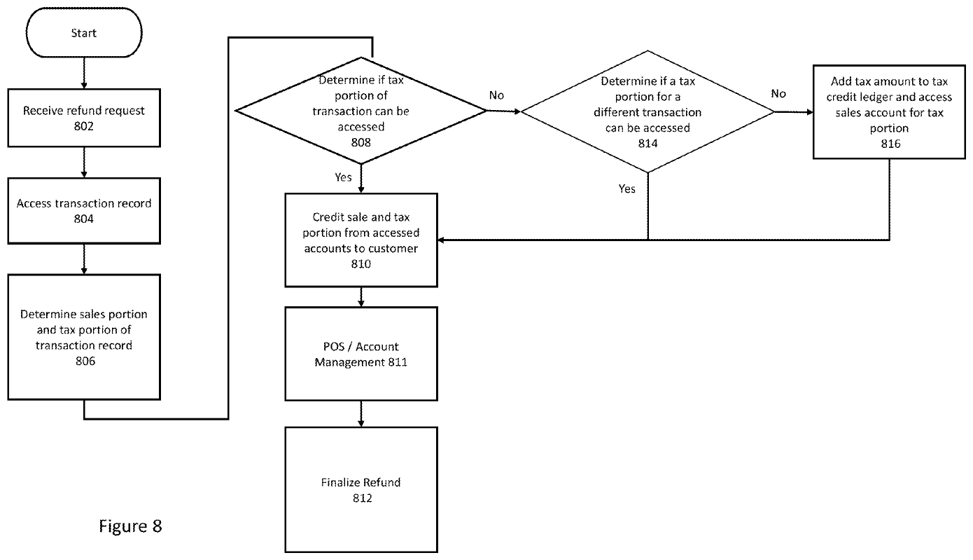

Turning now to the flow diagram of FIG. 8, a system is provided that takes a transaction that has been bifurcated according to the foregoing descriptions and explanations and reverses such a transaction. By way of broad overview and example, such an approach is used in circumstances when a customer seeks to obtain a refund for a good or service purchased from a merchant. For instance, transaction reversals are necessary when a customer seeks to return a purchased item and have the merchant credit the customer's credit or debit card the full amount paid in the transaction. Alternatively, where the customer used a gift card, voucher, or store credit to settle the transaction to be reversed, the merchant may provide the customer a credit to a store account for the complete transaction amount. In either circumstance, the amount credited or provided to the customer will match the full transaction price paid by the customer.

As noted, reversing a bifurcated transaction can introduce additional complexity into the transaction. For example, depending on the configuration of the transaction processing system of point of sale (POS), the tax portion of the transaction to be reversed has already been settled to an account that the merchant has not been provided withdrawal access. In such a circumstance, the merchant is unable to access the tax portion and credit the customer for the total sales price. Instead, the merchant is faced with providing the refund, for the entire transaction amount, of out the merchant's own account. Here, the taxing authority has received tax monies for a sale that has been reversed and credited by the merchant. As such, the merchant has a virtual credit with the taxing authority for monies it has paid on sales that have been reversed. It will be appreciated that simply requesting payment from the taxing authority each time a virtual credit occurs is an unwieldy and time-consuming approach to resolving this circumstance.

Thus, in order to rectify this deficiency, the transaction processor is able to, automatically, or otherwise without human intervention, access either alternative funds in tax account accessible to the merchant or generate a tax credit transaction record of the virtual credits reflecting payments made to customers where the taxing authority has received tax payments. Depending on further implementations described herein, upon receiving a new transaction to be bifurcated, the POS or payment processor is configured to access the tax portion of the new transaction and credit the merchant for outstanding virtual tax credits held by the merchant.

By way of further explanation, where a payment to a merchant was processed according to steps 280-294 of FIG. 2, the merchant has bifurcated the transaction amount and settled a portion of the transaction into a first account and a second portion, representing the tax due, to a second settlement account. As used in the foregoing examples, the tax account can be either an account accessible by the merchant where tax portions of a bifurcated transaction are settled. In this configuration, the merchant is able to access and withdraw available funds settled to this second account. In an alternative configuration, the second account is a tax authority account that does not provide the merchant with withdrawal access.

Turning now to FIG. 8, a payment processing workflow is initiated that effectuates the reversal of a customer transaction, such as the transaction originally settled in the flow diagram of FIG. 2. Here, a central transaction processor system, such as the POS systems previously described and/or similar to that depicted in FIG. 5, receives a request to reverse a bifurcated transaction. For instance, the central transaction processing system 900 is configured by a refund request module 902 which comprises code executing in a processor of a machine and operative to receive a request to reverse a prior transaction. As shown in step 802, such a request can be initiated by a customer (such as in the case of an online merchant) or by a merchant operating a POS. In one or more implementations, the refund request includes one or more data values associated with the transaction. For instance, the refund request received by a transaction processor 900 in step 802 includes data values that correspond to a unique transaction identifier, such as an alphanumeric string. The refund request can also include one or more data values including, the customer name, payment form, transaction amount, transaction type, or other relevant data generated by the POS or the customer at the time that a refund request is initiated.

Once the refund request is received, a point of sale or payment transaction processor 900 is configured by a transaction reversal module 901 that is operative to refund the payment made by the customer to an account of the customer's choosing. Such a transaction module, in one or more implementations, incorporates one or more additional modules (904-916) that instruct the transaction processor 900 to implement various procedures, processes or functions relating to accessing funds from identified account and settling those funds in favor of a customer account.

By way of example, the transaction processor 900 accesses the transaction record for the transaction to be reversed, as shown in step 804. The transaction processor 900 is configured by a transaction access module 904 which comprises code executing in a processor of the transaction processor 900 and is operative to access a stored transaction ledger or database. By way of example, a suitably configured payment processor 900 accesses a transaction database (such as database 903) and accesses details of the transaction to be reversed. Here, the details of the transaction accessed in access step 804 can include the total transaction amount, the date of the transaction, the bifurcated portions of the transaction (i.e. merchant portion and tax portion), and the account number for each account where a portion of the transaction amount was settled.

Using the data accessed from the transaction record, the transaction processor 900 is able to determine the transaction amount to be refunded to the customer. As shown in step 806, the transaction processor 900 determines, using the transaction data, the accounts where the sales portion and the tax portion of the bifurcated transaction were settled. For instance, the transaction processor 900 is configured by a settlement determination module 906 which comprises code executing in a processor of a machine and is operative to access the settlement accounts where portions of the transaction were settled. By way of non-limiting example, where the original transaction was bifurcated into a merchant portion and a tax portion, and the merchant and tax portions were settled to a first and second respective account, the settlement determination module 906 configures the transaction processor 900 to determine and access the accounts where the respective portions of the transaction were settled.

In yet a further implementation of step 806, the original transaction was bifurcated and evaluated using a fee resolution module. Where the bifurcated transaction included on or more processing fees determined and settled using a fee resolution module, such fees are not used to determine the amount to be credited to the customer. However, in some circumstances, such fees are deducted from the merchant portion due to be refunded to the customer. The transaction processor 900 is configured in one or more implementations to access from the transaction record the funds paid in fees for the transaction and deduct these fees from the amount to be credited to the customer.

As shown in step 808, the transaction processor 900 is configured by an account access module 908, which comprises code executing in a processor of a machine and is operative to determine the amounts, if any, that can be transferred from the accounts identified in step 806. Here, the transaction processor 900 is configured by an account transfer module 908 to initiate funds transfer, or other credit actions, that credits the customer's account with the both the sales and tax portion paid during the original transaction from a merchant's own account. By way of further explanation and as noted, the transaction bifurcation system described herein is configured in one or more implementations to process transactions at pre-determined time intervals. For instance, the transaction processor 900 bifurcates and settles the relevant transactions on an individual transaction basis. In other implementations, the transaction processor 900 processes or settles the tax portion to a taxing authority account on a daily, weekly or some other time interval. For example, the tax portion of a given bifurcated transaction may be held in a merchant accessible tax account until a scheduled transfer of the tax portions to a taxing authority account.

In one or more implementations, at the time the refund request is received by the transaction processor 900, the tax portion of the bifurcated transaction has not yet been paid to tax authorities. In this scenario, the transaction processor 900 configured by the account transfer module 908 to transfer an amount equal to the tax portion of the reversed transaction from the merchant accessible tax account to the customer's account, as shown in step 810. Furthermore, the account transfer module 908 also configures the transaction processor 900 to access the merchant account where the sales portion of the bifurcated transaction has been settled and cause a transfer or credit to the customer from that account for the sales portion of the bifurcated transaction.

For example, as shown in step 811, one or more submodules of the account transfer module 908 causes an account to be created or accessed for a customer. In circumstances where the original transaction was tendered in cash, there is no customer account to credit. Thus, a temporary customer can be used or generated by one or more submodules of the account transfer module 908. For example, the account transfer module 908 generates an instruction set for transmission to the merchant POS, which generates a temporary account that can be credited with the refund determined in step 810. As used herein, customer accounts can be temporary, transient or virtual accounts provided in connection with POS that allows a transaction to be completed. To the extent that a customer account is not necessary to complete the transaction, such an account is not used. This temporary account allows the POS to credit to a customer cash from a cash register (as part of the POS 907). In one implementation, the cash register, either integrated with the POS 907, or separately connected to the POS, receives an instruction to open, so that the refund amount may be provided. In one or more further implementations, where the cash register or cash tender system can dispense funds automatically, the instructions sent include both the instruction to open, as well as the necessary details to permit accurate dispensing of the proper funds.

Where the transaction was originally processed using a credit card processor, the refund will be credited back to the customer's credit card account.

As shown in step 812, once the customer receives the funds, either from the POS directly as a credit to a customer account, transaction records or databases are updated to reflect the reversed bifurcated transaction. For example, the transaction processor 900 is configured by an update module 912 to access one or more accounting systems and/or records, such as transaction record 903. Here, the configured transaction processor 900 provides data corresponding to the completed refund transaction. In one implementation, the transaction processor provides an accounting system and/or transaction record with data indicating the original transaction, the refund requested, the amount refunded and the tax and sales portions thereof. In this way accurate records can be provided to the taxing authorities if necessary. As such, in the case of a cash transaction, the amount of funds present in the cash register will correspond to the updated transaction record.

Returning to step 808, in certain implementations the tax portion for the bifurcated transaction has already been provided to a taxing authority account that is inaccessible to the transaction processor. For instance, if the tax portion of the original bifurcated transaction is immediately settled to a taxing authority account, the tax portion cannot be retrieved and credited as provided in steps 808-810. Instead, one or more submodules of the settlement determination module 906 configures the transaction processor 900 to determine if the tax portion for one or more additional bifurcated transactions has been settled to an account accessible to the transaction processor 900.

As shown in step 814, the transaction processor 900 is configured by one or more submodules of the settlement determination module 906 to identify a transaction that has been bifurcated but the tax portion has not been settled to a taxing authority account. Where such funds are identified, the transaction processor 900 is further configured by the account transfer module 908 to access such funds and evaluate the accessed funds against the tax portion due to be refunded to the customer. For instance, the transaction processor 900 is configured by the account transfer module 908 to compare the funds in the accessed account, where such funds represent tax portions awaiting settlement to a taxing authority, and transfer some or all of the accessed funds to the customer's account to satisfy the refund request.

By way of non-limiting example, the transaction processor 900 is configured to access the transaction a tax account, accessible to the merchant, that has a balance of $50.00. This $50.00 of funds represents one or more tax portions for bifurcated transactions where the tax portion has not been settled to a taxing authority account. Where the tax portion for a reversed transaction is $10.00, the account access module 908 configures transaction processor 900 to credit $10.00 of the $50.00 balance to the customer's account, thereby refunding the tax portion of the transaction as shown in step 810. Alternatively, the $10.00 is credited to the merchant's sales account and the customer is credited the full amount from that account, such that both the sales and tax portion of the bifurcated account originate from the same account. The details of such a credit transaction are provided to one or more transaction records by a transaction processor 900 configured by the update module 912 as provided in step 812.

It will be appreciated that in certain circumstances, there will be insufficient funds to refund the entire amount of taxes paid by the customer in the transaction to be reversed. As provided in step 816, in such implementations, one or more submodules of the account transfer module 908 configures the transaction processor 900 to settle the tax portion of the bifurcated to the customer's account from the merchant account. Furthermore, the processor 900 is configured by a credit ledger module 916 to record the amount settled from the merchant account that corresponds to the tax portion. Here, the credit ledger module 916 configures the processor to access or generate a ledger in order to maintain an accounting of tax portions that have been paid by the merchant from funds not earmarked for the taxing authority.

By way of example, where the refund request requires crediting a customer account the tax paid on a reversed transaction, the transaction processor first queries the accessible account to determine if the tax portion paid by the customer has been settled to an account accessible to the transaction processor 900. If not, the transaction processor next queries the transaction record to determine if any tax portions from other transactions are accessible to the transaction processor 900 as in step 814.

Where there are no tax portions available to the transaction processor 900, or the tax portions are less than the required tax refund to customer, the transaction processor 900 is configured settle the remaining balance of the tax refund due to the customer from the merchant account and add the remaining balance to a tax credit ledger. For example, in a cash tendered transaction, the transaction processor instructs a POS or other system to open a cash register to credit the customer out of the merchant on-hand cash. Next, the tax credit ledger records or stores reference to a tax payment that was due to be refunded to a customer as part of the refund, but which has already been paid to a taxing authority. Such a ledger forms the record of tax credits held by the merchant against future tax funds owed to the taxing authority.

By way of particular example, the reversed transaction includes a $10 tax portion and the original tax portion has been provided to a taxing authority. Here, the transaction processor 900 is configured to evaluate any accessible tax account of the merchant. Where all of the accessible tax accounts have a balance of $0.00, representing that all tax portions have been settled to taxing authority accounts, then the tax credit ledger module 916 configures the transaction processor 900 to update the credit ledger reflect the $10.00 shortfall. Once the shortfall has been recorded, the remaining tax amount is accessed from the merchant's available accounts, such as a sales account, and the full amount is settled to the customer account, as in step 810. Once the refund has been completed, the transaction processor 900 finalizes the refund and updates any relevant records as in step 812

By way of further example, the reversed transaction includes a $10.00 tax portion and the original tax portion has been provided to a taxing authority. Here the transaction processor 900 is configured to evaluate any accessible tax account of the merchant. Where one of the accessible tax accounts has a balance of $5.00, representing that a tax portions of a transaction that has yet to be settled to a taxing authority, the tax credit ledger module 916 configures the transaction processor 900 to update the credit ledger reflect the $5.00 shortfall. Once the shortfall has been recorded, the $5.00 is accessed from the available tax account, and the remaining $5.00 is accessed from another merchant account, such as a sales account, and the full tax portion amount is settled to the customer account, as in step 810. Once the refund has been completed, the transaction processor finalizes the refund and updates any relevant records as in step 812

In a further implementation, if there is no existing credit ledger, then the credit ledger module 916 instantiates a credit ledger and provides the transaction processor 900 access to the credit ledger. In one or more implementations, the credit ledger is a database (such as database 905) that stores data describing tax payment made to a customer that the merchant needs to be reimbursed for. In an alternative implementation, the credit ledger is implemented as a distributed ledger using one or more peer-to-peer protocols, such as but not limited to Blockchain or similar distributed ledger implementations.

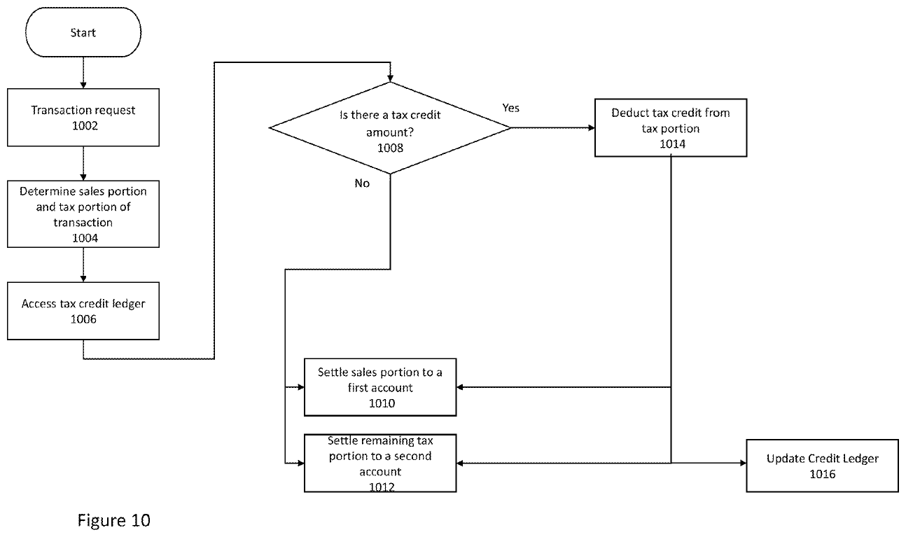

Turning now to FIG. 10, in the event that there is an existing balance in the credit ledger, subsequent bifurcated transactions are evaluated to reduce and eventually eliminate the credit ledger balance. For example, as shown is steps 1002 a new transaction request is provided to the transaction processor. Such as request is similarly described with respect to the flow diagram of FIG. 5. Likewise, the process of bifurcating the requested transaction, as shown is step 1004, is similar to the work flow provided in FIGS. 2 and 5.

Turning now to step 1006, after the transaction is bifurcated, the tax credit ledger is accessed, and the balance provided therein is determined. To clarify, the balance of the tax credit ledger reflects previous tax amounts that were refunded to a customer out of the merchant's own account(s). That is, the balance reflects money that has been paid to the taxing authority for certain bifurcated transactions that have been reversed after the payment to the taxing authority.

As shown in step 1008, the transaction processor 900 is configured by the credit ledger module 916 to determine the balance of credits available to the merchant. Where there are no credits available to the merchant from the credit ledger, the transaction processor settles the bifurcation payments to sales account and a tax account, as shown in steps 1010 and 1012 respectively. It will be appreciated that such settlement approaches are descried herein in connection with workflow described in at least FIGS. 2, 5 and 7.

Where the transaction processor, configured by the credit ledger module 916, determines that credits are available to the merchant, the workflow proceeds to a deduction step 1014. In one particular implementation, the transaction processor 900 is configured by the account settlement module 906 to adjust the relative amounts of the bifurcated transaction to account for the credits provided in the credit ledger. By way of nonlimiting example, where the tax portion of a bifurcated transaction is $10.00, and the credit ledger records an existing tax credit balance of $2.00, the transaction processor is configured by the account settlement module 906 to adjust the tax portion of the bifurcated transaction to be $8.00, with the other $2.00 being credited to the sales portion of the bifurcated transaction. Once the adjustment has been made, the adjusted amounts are settled according to steps 1010 and 1012 respectively. In a further step, the fees associated with resolving the tax portion in step 1012 are resolved. Such resolution can be carried out as provided in step 730 of the workflow described in FIG. 7.

Once the relative amounts have been adjusted, the transaction processor 900 is configured by the credit ledger module 916, as shown in step 1016, to update the credit ledger to deduct the amount credited to the merchant account from the remaining balance of the credit ledger.

In a further implementation, the tax credit ledger is used to generate a tax credit record for the merchant. By way of non-limiting example, the tax credit record maintains a record of each reversed transaction where the merchant has refunded the customer the entire sale price (including tax) and the merchant has not been reimbursed or credited the tax amount from the tax account. In one or more implementations (not shown), the credit ledger module 916 configures the transaction processor 900 to generate one or more tax credit documents at periodic intervals reflecting the present balance of the tax credit ledger. For instance, every tax reporting period (i.e. monthly, quarterly, yearly), the credit ledger module 916 configures the transaction processor to generate an electronic file, credit note or other document that indicates the amount of taxes paid on transactions that have subsequently been reversed. This document can then be used by the merchant as proof of a claimed tax credit when filing the merchant taxes.

While certain features of the present invention have been described as occurring on a particular machine, it would be understood by one of ordinary skill in the art that the functions described herein can be performed by various machines, interconnected, and distributed over a network. The determination of which machines perform specific functions is determined by the specific software implementation and supported hardware platforms. Accordingly, the present invention can operate in a centralized environment, wherein a server is responsible for substantially all processing, and the clients display the virtual environment and communicate user-interaction to the server. Alternatively, the present invention can also be practiced in a peer-to-peer environment having little or no centralized processing, wherein the state of each client is shared with its peers as necessary and the simulation of the virtual environment is distributed across the peer network.

While the present invention has been described with respect to certain embodiments thereof, the invention is susceptible to implementation in other ways and manners which are still within the spirit of the invention. Accordingly, the invention is not limited to the described embodiments but rather is more broadly defined by the recitations in the claims appended thereto and equivalents of the recitations therein.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems maybe cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference in their respective entireties to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

We claim:

1. A transaction processing system suitable for reversing a merchant transaction, the system comprising:
a computer having a processor, a memory, a first connection over a network for receiving a request to reverse the merchant transaction, and further connections over the network for reversing the merchant transaction; and
a transaction reversal module comprising code which, when executed in the processor, configures the processor to provide funds associated with the request to reverse the merchant transaction received over the first connection to a customer, where the merchant transaction bifurcated the funds into a merchant portion and a tax portion, the transaction reversal module including:
a transaction access module operative to configure the processor to identify a first account where the merchant portion was settled and a second account where the tax amount was settled;
a settlement determination module operative to configure the processor to determine if the tax portion is accessible from the second account;
an account transfer module operative to configure the processor to settle the merchant portion in favor of a customer account from the first account; and settle the tax portion from the second account where the tax portion is accessible from the second account or settle the tax portion in favor of the customer account using one or more alternative fund sources where the tax portion is not accessible from the second account; and
a credit ledger module operative to configure the processor to access and update a credit ledger, wherein the credit ledger includes data relating to one or more tax portion payments settled to a customer account using the one or more alternative fund sources.

2. The transaction processing system of claim 1, where the credit ledger includes a real-time tax payment balance reflecting one or more tax portions settled in favor of the customer account using one or more of the alternative fund sources.

3. The transaction processing system of claim 1, wherein at least one of the alternative fund sources is unsettled funds accessible in the second account.

4. The transaction processing system of claim 3, where the credit ledger module further configures the processor to record the settlement of the unsettled funds accessible in the second account.

5. The transaction processing system of claim 1, wherein at least one of the alternative fund sources is funds settled to the first account.

6. The transaction processing system of claim 3, wherein at the one or more alternative fund sources includes funds settled to the first account and unsettled funds accessible in the second account.

7. A transaction processing system of claim 2, the system further comprising:
a separator module comprising code which, when executed in the processor, configures the processor to separate funds associated with a subsequent merchant transaction received over the first connection, the separator module including:
a revenue settlement module operative to configure the processor to settle a revenue portion of the subsequent merchant transaction in favor of a primary account accessible over the network, the primary account being associated with the merchant, wherein the revenue portion excludes a tax portion of the merchant transaction; and
a tax settlement module operative to configure the processor to access at least the tax payment balance from the tax credit ledger, compare the tax payment balance to the tax portion of the subsequent merchant transaction and either settle the tax portion to the primary account where the tax balance is greater than or equal to the tax portion or settle a first portion equal to or less than the tax payment balance of the tax portion of the merchant transaction to the first account where the tax portion is greater than the tax payment balance and settle a second portion of the tax portion associated with the merchant transaction in favor of a secondary account accessible over the network where the tax portion, after deducting the tax payment balance, is greater than zero, the secondary account being different than the primary account.

8. The transaction processing system as in claim 7, further comprising an update module operative to configure the processor to update the credit ledger to deduct the credit amount from the tax payment balance.

9. The transaction processing system as in claim 6, further comprising a fee resolution module operative to configure the processor to resolve at least one fee associated with operation of the tax settlement module, such that an amount equal to the tax portion is settled in favor of the second account.

10. The transaction processing system as in claim 9, wherein the fee resolution module is configured to appropriate funds from a substitute source equal to the at least one fee; and
augment the second account with the appropriated funds in the event that the at least one fee is drawn from either the tax portion or the second account.

11. The transaction processing system as in claim 9, wherein the fee resolution module is configured to:
isolate the tax portion from being subject to a disbursement of the at least one fee during operation of the tax settlement module; and
discharge the at least one fee by either notifying a requester of the at least one fee to draw the at least one fee from an alternative source or by providing the requester with the fee from the alternative source.

12. A method for providing a transaction processing system suitable for reversing a merchant transaction, the system including a computer having a processor, a memory, a first connection over a network for receiving a request to reverse the merchant transaction, and further connections over the network for reversing the merchant transaction; a transaction reversal module comprising code which, when executed in the processor, configures the processor to provide funds associated with the request to reverse the merchant transaction received over the first connection to a customer, where the merchant transaction bifurcated the funds into a merchant portion and a tax portion, the transaction reversal module including:
identifying, using a transaction access module operative to configure the processor, a first account where the merchant portion was settled and a second account where the tax amount was settled;
determining, using a settlement determination module operative to configure the processor, if the tax portion remains in the second account;
settling, using an account transfer module operative to configure the processor, the merchant portion in favor of a customer account; and either settling the tax portion from the second account where the tax portion remains in the second account and settling the tax portion in favor of the customer account using an alternative fund source where the tax portion is not present in the second account; and
accessing, using a credit ledger module operative to configure the processor, a credit ledger, wherein the credit ledger includes data relating to one or more tax portion payments settled to a customer account using the alternative fund source and updating the credit ledger to record one or more tax portion payments settled to a customer account using the alternative fund.

13. The transaction processing system of claim 12, where the credit ledger includes a real-time tax payment balance reflecting one or more tax portions settled in favor of the customer account using the alternative fund source.

14. The transaction processing system of claim 13, wherein the alternative fund source is additional funds present in the second account.

15. The transaction processing system of claim 12, wherein the alternative fund source is the first account.

16. The transaction processing system of claim 14, wherein at the one or more alternative fund sources includes funds settled to the first account and additional funds accessible in the second account.

17. A method for providing a transaction processing system suitable for processing a merchant transaction, the system including a computer having a processor, a memory, a first connection over a network for receiving the merchant transaction, and further connections over the network for settling the merchant transaction, and a separator module comprising code which, when executed in the processor, configures the processor to separate funds associated with the merchant transaction received over the first connection, the method comprising:
settling, by the separator module executing in the processor, a revenue portion of the merchant transaction in favor of a primary account accessible over the network, the primary account being associated with the merchant, wherein the revenue portion excludes a tax portion of the merchant transaction; and
accessing, by the separator module executing in the processor, at least the tax payment balance from the tax credit ledger and comparing the tax payment balance to the tax portion of the merchant transaction and deducting the value of the tax payment balance from the tax portion of the merchant transaction where the tax portion is greater than zero to obtain a credit amount; settling the credit amount in favor of the primary account and settling the tax portion associated with the merchant transaction in favor of a secondary account accessible over the network where the tax portion after deducting the tax payment balance is greater than zero, the secondary account being different than the primary account.

18. The method of claim 17, further comprising updating, by an update module operative to configure the processor, the credit ledger to deduct the credit amount from the tax payment balance.

19. The method of claim 17, further comprising resolving, by a fee resolution module operative to configure the processor, at least one fee associated with operation of the tax settlement module, such that an amount equal to the tax portion is settled in favor of the second account.

20. The method of claim 1, wherein the customer account is a temporary, transient or virtual account provided in connection with a point of sale system.

21. The method of claim 20, wherein the transaction reversal module further comprising a instruction module operative to configure a processor to instruct a point of sale system to provide access to physical tender to settle the transaction to the customer account.
